(19) United States
(12) Patent Application Publication
(10) Pub. No.: US 2025/0162145 A1
(43) Pub. Date: May 22, 2025

(54) ROBOT PROGRAMMING SYSTEM AND ROBOT CONTROL DEVICE

(71) Applicant: FANUC CORPORATION, Yamanashi (JP)

(72) Inventor: Hiroyuki YONEYAMA, Yamanashi (JP)

(21) Appl. No.: 18/841,674

(22) PCT Filed: Mar. 23, 2022
(86) PCT No.: PCT/JP2022/013638

§ 371 Date: Aug. 27, 2024

(51) Int. Cl. B25J 9/16

(52) U.S. Cl. CPC B25J 9/1656

(57) ABSTRACT

A robot programming system comprises: a first information processing unit having a code conversion unit that converts a robot program into a code; a visual sensor that captures an image of the code displayed on an information medium; and a robot control device that controls a robot and that includes a code analysis unit which analyzes the captured image of the code to restore the robot program, and includes a robot program duplication unit which duplicates the restored robot program and stores same in a memory unit.

### FIELD

The present invention relates to a robot programming system and a robot control device.

### BACKGROUND

As a technique for creating a robot program for controlling a robot to perform motion, a technique for teaching motion to an actual robot by operating a teach pendant (see PTL 1), and a technique for teaching a robot program by arranging a three-dimensional model of a robot system on a virtual space of a programming device (see PTLs 2 to 4) have been known.

PTL 5 relates to a detection device that detects a two-dimensional code attached to an object and generates control information for the object, and describes as follows: “A two-dimensional code detection device 1 includes: an image input means 2 for inputting an image captured by a camera C; an image analysis means 4 for analyzing the captured image, calculating position/posture information indicating a position and a posture of a two-dimensional code M, based on a unique pattern of the two-dimensional code M in the captured image, and also decoding information encoded in the two-dimensional code M; and a control information generation means 5 for generating control information corresponding to the object provided with the two-dimensional code M, based on the position/posture information and the decoded information.” (abstract).

PTL 6 relates to a robot simulation image display system, and describes as follows: “Model number information T about a robot and a demonstration program SP for operating a three-dimensional image model M are recorded in a QR code (registered trademark) 4, a personal computer 2 acquires posture information, i.e., a rotation matrix Mr in a three-dimensional space of the QR code (registered trademark) 4 from four points P1 to P4 on a screen corresponding to four points Q1 to Q4 in image data of the QR code (registered trademark) 4 captured by a camera 1, wherein a reference point CO is the origin of three-dimensional coordinates, directions along Q1and Q2 from the origin are an X-axis and a Y-axis, and a normal line on the origin on an XY plane is a Z-axis, multiplies three-dimensional image data R by the rotation matrix Mr, and displays the three-dimensional image model M on a display 5. In accordance with change of a position and a posture of the QR code (registered trademark) 4 in an image captured by the camera 1, a position and a posture of the three-dimensional image model M is also changed, and the three-dimensional image model M is operated in the three-dimensional space display according to the demonstration program SP.” (abstract).

PTL 7 relates to a program creation support system using a computer, and describes as follows: “A plurality of chips with pictures with which instructions are associated in advance and a predetermined sheet on which the chips are arranged are prepared. A user selectively arranges a plurality of chips on the sheet according to a purpose. The array of the chips is photographed by a camera provided in a portable terminal such as a smartphone. A processing device (for example, a server) in the program creation support system recognizes an image of the picture of each chip from an image of the array of the chips acquired by the camera, specifies an instruction code constituting a program, and creates program data from the array of instruction codes.” (paragraph 0015).

### CITATION LIST

### Patent Literature

[PTL 1] Japanese Unexamined Patent Publication (Kokai) No. H11-249725 A

[PTL 2] Japanese Unexamined Patent Publication (Kokai) No. 2016-101644 A

[PTL 3] Japanese Unexamined Patent Publication (Kokai) No. 2018-51692 A

[PTL 4] Japanese Unexamined Patent Publication (Kokai) No. 2017-140684 A

[PTL 5] Japanese Unexamined Patent Publication (Kokai) No. 2007-90448 A

[PTL 6] Japanese Unexamined Patent Publication (Kokai) No. 2010-179403 A

[PTL 7] Japanese Unexamined Patent Publication (Kokai) No. 2018-136446 A

### SUMMARY

### Technical Problem

When a robot program created by teaching motion to a robot system model arranged on a virtual space is applied to an actual robot system, there are cases where a robot program is stored in a storage medium such as a USB memory, and the storage medium is inserted into a control device of an actual robot to read the robot program into the control device. The application of a robot program to an actual robot system in such a form is time-consuming work. For example, when a great number of the same robot systems are operating in a factory, it requires a particularly great amount of time and effort.

### Solution To Problem

One aspect of the present disclosure is a robot programming system including: a first information processing device including a code conversion unit configured to convert a robot program into a code; a visual sensor configured to capture an image of the code displayed on an information medium; and a robot control device configured to control a robot, and the robot control device includes: a code analysis unit configured to analyze a captured image of the code so as to restore the robot program; and a robot program duplication unit configured to duplicate the restored robot program and store the duplicated robot program in a storage unit.

Another aspect of the present disclosure is a robot control device configured to control a robot and includes: a code acquisition unit configured to acquire information about an image of a code encoding a robot program, the image being captured by a visual sensor; a code analysis unit configured to analyze the information about the image of the code so as to restore the robot program; and a robot program duplication unit configured to duplicate the restored robot program and store the duplicated robot program in a storage unit.

Still another aspect of the present disclosure is a robot control device configured to control a robot and includes: a code acquisition unit configured to acquire information about an image of a code encoding a robot program for performing work depending on a workpiece, wherein the code is attached to the workpiece and the image is captured by a visual sensor; a code analysis unit configured to analyze the information about the image of the code so as to restore the robot program; a robot program duplication unit configured to duplicate the restored robot program and store the duplicated robot program in a storage unit; and a program execution unit configured to execute the duplicated robot program.

### Advantageous Effects Of Invention

Time and effort required when a motion program created by a programming device is applied to a robot system can be greatly reduced as compared to the case where the application of a motion program to a robot system is performed by using a USB memory and the like.

The objects, the features, and the advantages, and other objects, features, and advantages will become more apparent from the detailed description of typical embodiments of the present invention illustrated in accompanying drawings.

### BRIEF DESCRIPTION OF DRAWINGS

FIG. 1 is a diagram illustrating an apparatus configuration of a robot programming system according to a first embodiment.

FIG. 2 is a diagram illustrating a hardware configuration example of a programming device, a robot control device, and a teach pendant.

FIG. 3 is a functional block diagram of the programming device, the robot control device, and a device for displaying a two-dimensional code according to the first embodiment.

FIG. 4 is a flowchart illustrating robot program duplication processing according to the first embodiment.

FIG. 5 is a diagram illustrating operations according to a first example, and illustrates a state where a robot system model is arranged in a virtual space.

FIG. 6 is a diagram illustrating operations according to the first example, and illustrates a state where a robot program is created.

FIG. 7 is a diagram illustrating operations according to the first example, and illustrates a state where a two-dimensional code representing the robot program is generated.

FIG. 8 is a diagram illustrating operations according to the first example, and illustrates a state where an image of the two-dimensional code is captured in an actual robot system.

FIG. 9 is a diagram illustrating operations according to the first example, and illustrates a state where the robot program is duplicated in the actual robot system.

FIG. 10 is a diagram illustrating operations according to a second example, and illustrates a state where a robot program is divided into a plurality of robot programs and two-dimensional codes are generated.

FIG. 11 is a diagram illustrating operations according to the second example, and illustrates a state where an image of the plurality of two-dimensional codes generated by dividing the robot program is captured in an actual robot system.

FIG. 12 is a diagram illustrating operations according to the second example, and illustrates a state where the robot program is duplicated in the actual robot system.

FIG. 13 is a diagram illustrating operations according to a third example, and illustrates a state where a two-dimensional code representing a robot program created by an actual robot system is generated.

FIG. 14 is a diagram illustrating a case where a programming device is formed of a tablet terminal, and the tablet terminal is also used as a display device that displays a two-dimensional code.

FIG. 15 is a diagram illustrating a state where an image of a two-dimensional code displayed on the tablet terminal is captured in the actual robot system.

FIG. 16 is a diagram illustrating a state where a programming device formed of a PC generates a robot program, and a two-dimensional code representing the robot program is generated.

FIG. 17 is a diagram illustrating the generated two-dimensional code is transmitted by an e-mail or printed out.

FIG. 18 is a diagram illustrating a state where an image of the two-dimensional code displayed on a paper medium is captured in the actual robot system.

FIG. 19 is a diagram illustrating an apparatus configuration of a robot programming system according to a second embodiment.

FIG. 20 is a functional block diagram of a programming device and a robot control device according to the second embodiment.

FIG. 21 is a flowchart illustrating robot program duplication processing according to the second embodiment.

FIG. 22 is a diagram illustrating a first creation example of a robot program depending on a workpiece, and illustrates a state where a robot system model is arranged in a virtual space.

FIG. 23 is a diagram illustrating the first creation example of the robot program having instructions depending on the workpiece, and illustrates a state where an edge line of the workpiece is designated.

FIG. 24 is a diagram illustrating the first creation example of the robot program having instructions depending on the workpiece, and illustrates a state where the robot program for processing the designated edge line is generated.

FIG. 25 is a diagram illustrating a second creation example of a robot program having instructions depending on a workpiece, and illustrates a state where a picking-up position and the like of a work target are designated.

FIG. 26 is a diagram illustrating the second creation example of the robot program having instructions depending on the workpiece, and illustrates a state where the robot program is generated.

FIG. 27 is a diagram illustrating a state where a two-dimensional code representing the robot program created in the first creation example is generated.

FIG. 28 is a diagram illustrating a state where an image of the two-dimensional code representing the robot program created in the first creation example is captured in an actual robot system.

FIG. 29 is a diagram illustrating a state where the robot program created in the first creation example is executed in the actual robot system.

FIG. 30 is a diagram illustrating a state where a different workpiece is carried into the robot system and an image of a two-dimensional code attached to the workpiece is captured.

FIG. 31 is a diagram illustrating a state where the robot program is executed on the different workpiece.

### DESCRIPTION OF EMBODIMENTS

Next, embodiments of the present disclosure will be described with reference to drawings. A similar configuration portion or a similar functional portion is denoted by the same reference sign in the referred drawings. A scale is appropriately changed in the drawings in order to facilitate understanding. An aspect illustrated in the drawing is one example for implementing the present invention, and the present invention is not limited to the illustrated aspect.

Hereinafter, a robot programming system according to a first embodiment and a second embodiment will be described. The robot programming system according to the first embodiment and the second embodiment is formed as a robot programming system including: a first information processing device including a code conversion unit that converts a robot program into a code; a visual sensor that captures an image of the code displayed on an information medium; and a robot control device that controls a robot. The robot control device includes a code analysis unit that analyzes the captured image of the code so as to restore the robot program, and a robot program duplication unit that duplicates the restored robot program and stores the duplicated robot program in a storage unit. The first information processing device is, for example, a programming device for creating a robot program. In this configuration, the robot program created on the programming device is converted into a code and displayed on an information medium such as a device and various media. In an actual robot system, a robot (robot control device) captures an image of the code displayed on the information medium by using a visual sensor, analyzes the captured image, and restores and duplicates the robot program.

### First Embodiment

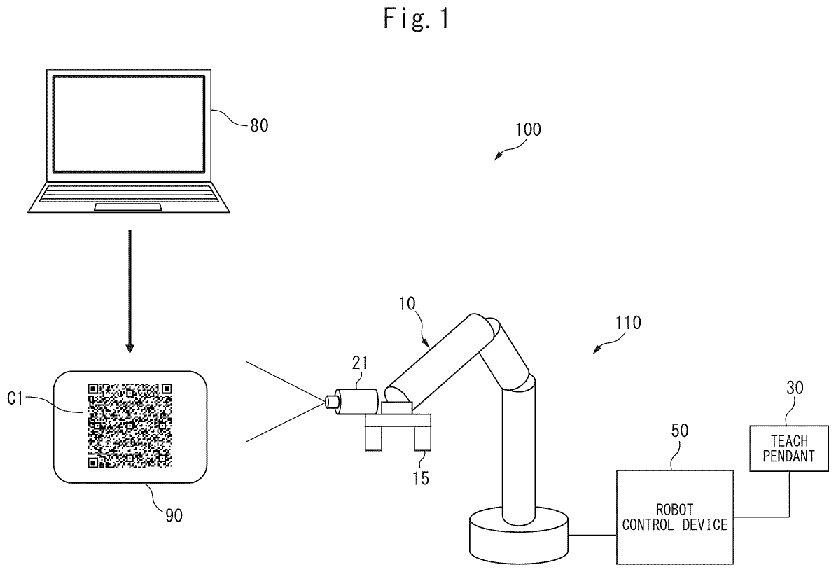

FIG. 1 is a diagram illustrating an apparatus configuration of a robot programming system 100 according to the first embodiment. As illustrated in FIG. 1, the robot programming system 100 includes a programming device 80 having functions of creating a robot program and converting the robot program into a code, and a robot system 110 having functions of capturing an image of the code displayed on an information medium 90 by a visual sensor 21, and restoring and duplicating the robot program.

As a code representing information about a robot program and the like, various codes including a one-dimensional code and a two-dimensional code can be used, and a two-dimensional code is used in the present embodiment (and each of the embodiments described below). Through an image analysis, the code provides, as composite information, information encoded therein in a form of an encoding pattern.

The programming device 80 is a device that can create a robot program by arranging a robot system model including a robot model on a virtual space and teaching motion to the robot model on the virtual space. As the programming device 80, a personal computer (PC), a tablet terminal, and other various information processing devices may be used. A robot program created by the programming device 80 is converted into a two-dimensional code C1.

The generated two-dimensional code C1 is displayed on the information medium 90, and is arranged in a position that can be seen from the visual sensor 21 in a workspace of the robot system 110. In the present specification, the information medium includes various objects that can display a code, such as a display screen of an information processing device (such as a tablet terminal and a PC), paper, and other media.

When a display screen of an information processing device is used for displaying a two-dimensional code, for example, an information processing device such as a tablet terminal possessed by a worker may be used, or the programming device 80 itself may function as a device for displaying a two-dimensional code.

The robot system 110 includes a robot 10, a robot control device 50 that controls the robot 10, and a teach pendant (teaching device) 30 connected to the robot control device 50. The visual sensor 21 is mounted on an arm tip portion of the robot 10. The visual sensor 21 is connected to the robot control device 50, and operates under the control of the robot control device 50.

The robot 10 can perform desired work by using an end effector attached to a wrist portion of an arm tip of the robot 10. The end effector is an external device which can be exchanged according to use, and is, for example, a hand, a welding gun, a tool, and the like. FIG. 1 illustrates an example in which a hand 15 is used as the end effector.

By the configuration described above, the robot 10 (robot control device 50) can read and duplicate, by using the visual sensor 21, the two-dimensional code C1 created by the programming device 80 and displayed on the information medium 90. In this way, time and effort required to apply the robot program created by the programming device 80 to the robot system 110 can be greatly reduced as compared to the case where a USB memory, and the like is used to apply the robot program created by the programming device 80 to the robot system 110.

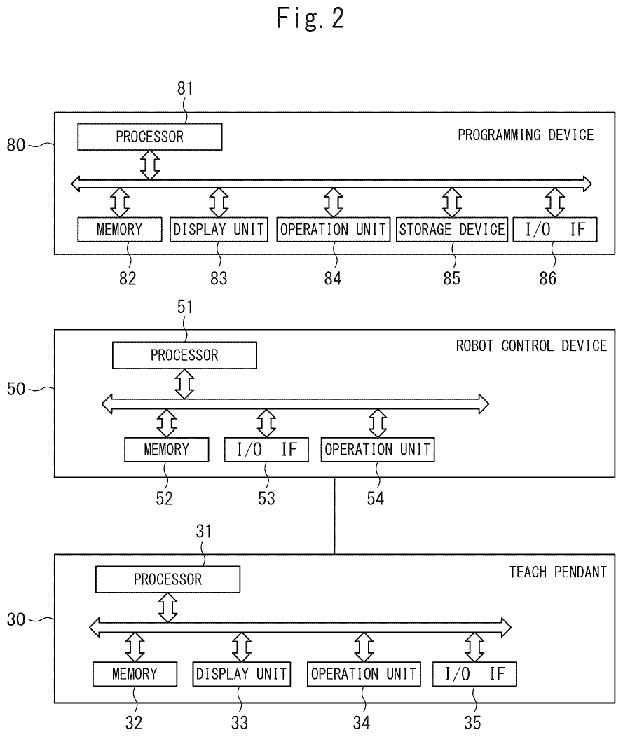

FIG. 2 illustrates a hardware configuration example of the programming device 80, the robot control device 50, and the teach pendant 30. The programming device 80 has a hardware configuration of a general computer in which a memory 82 (such as a ROM, a RAM, and a non-volatile memory), a display unit 83, an operation unit 84 formed of an input device such as a keyboard and a mouse, a storage device (such as an HDD) 85, various input/output interfaces 86, and the like are connected to a processor 81. The robot control device 50 may have a configuration as a general computer in which a memory 52 (such as a ROM, a RAM, and a non-volatile memory), various input/output interfaces 53, an operation unit 54 including various operation switches, and the like are connected to a processor 51 via a bus. The teach pendant 30 may have a configuration as a general computer in which a memory 32 (such as a ROM, a RAM, and a non-volatile memory), a display unit 33, an operation unit 34 formed of an input device such as a keyboard (or a software key), various input/output interfaces 35, and the like are connected to a processor 31 via a bus.

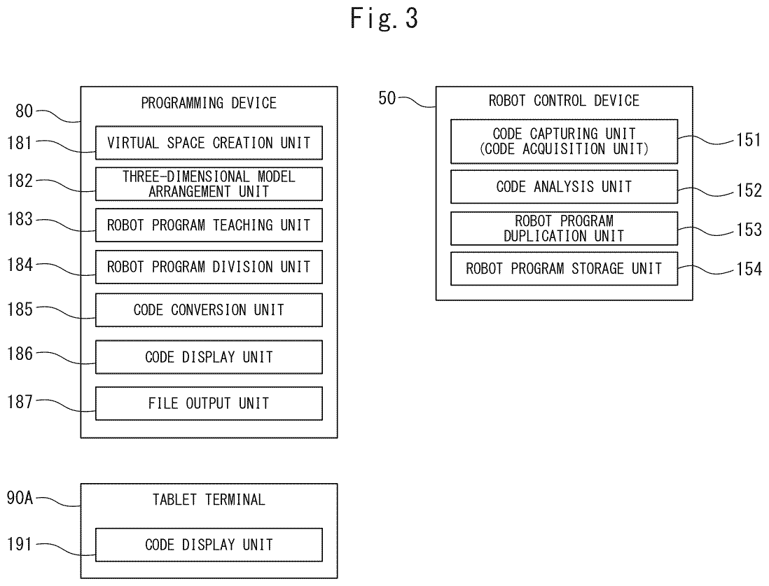

FIG. 3 is a functional block diagram of the programming device 80 and the robot control device 50. Further, FIG. 3 illustrates a functional block diagram of a tablet terminal 90A when the tablet terminal 90A is used as the information medium 90 for displaying a two-dimensional code.

As illustrated in FIG. 3, the programming device 80 includes a virtual space creation unit 181, a three-dimensional model arrangement unit 182, a robot program teaching unit 183, a robot program division unit 184, a code conversion unit 185, and a file output unit 187. It should be noted that the programming device 80 may include a code display unit 186 for allowing the programming device 80 itself to be used as a device for displaying a two-dimensional code.

The tablet terminal 90A includes a code display unit 191 for displaying the two-dimensional code transferred from the programming device 80.

The robot control device 50 includes a code capturing unit 151, a code analysis unit 152, a robot program duplication unit 153, and a robot program storage unit 154.

In the programming device 80, the virtual space creation unit 181 creates a virtual space for arranging various models constituting a robot system. The three-dimensional model arrangement unit 182 arranges a three-dimensional model of each object constituting the robot system including a robot model and the like in the virtual space, based on arrangement information about the actual robot system 110. The robot system model arranged in the virtual space is displayed on a display screen of the programming device 80.

The robot program teaching unit 183 provides the function of teaching motion to the robot model (i.e., performing programming) according to the user input, for example, by accepting an operation of designating a teaching point by a jog operation with respect to the robot model via a user interface screen and an operation of setting various setting parameters.

The robot program division unit 184 provides a function of dividing a robot program when the robot program is large, and the like.

The code conversion unit 185 converts the created robot program into a two-dimensional code. The code display unit 186 provides a function of displaying the created two-dimensional code on the display screen.

The file output unit 187 provides a function of outputting the created two-dimensional code as a file. The two-dimensional code output as the file may be transferred to the tablet terminal 90A by an e-mail function, or may be printed.

The code capturing unit 151 of the robot control device 50 provides a function of capturing, by using the visual sensor 21, an image of the two-dimensional code displayed on the information medium 90. For example, the code capturing unit 151 may operate to capture an image of the information medium 90 placed in advance within an image capturing area of the visual sensor 21, or may operate to move the robot 10 so as to capture an image of the information medium 90 placed at a predetermined position in a workspace. It should be noted that the function of the code capturing unit 151 can also be expressed as a code acquisition unit that acquires information about an image in which a code encoding the robot program is captured by the visual sensor 21.

It should be noted that the robot control device 50 may have, as an internal function, a function as a visual sensor control device that controls the visual sensor 21. Alternatively, the visual sensor control device that controls the visual sensor 21 may be provided, to the robot system 110, separately from the robot control device 50. In the latter case, the robot control device 50 controls the visual sensor 21 via the visual sensor control device, and acquires an image captured by the visual sensor 21 via the visual sensor control device.

By analyzing the captured image of the two-dimensional code, the code analysis unit 152 extracts a region of the two-dimensional code in the image, determines a position and a posture of the two-dimensional code, and decodes information encoded in the two-dimensional code so as to restore the robot program.

The robot program duplication unit 153 duplicates the restored robot program, and stores the duplicated robot program in the robot program storage unit 154.

By the functions of the robot control device 50, the robot program encoded in the two-dimensional code displayed on the information medium 90 is duplicated and stored in the robot control device 50. Accordingly, the robot control device 50 can execute the duplicated robot program.

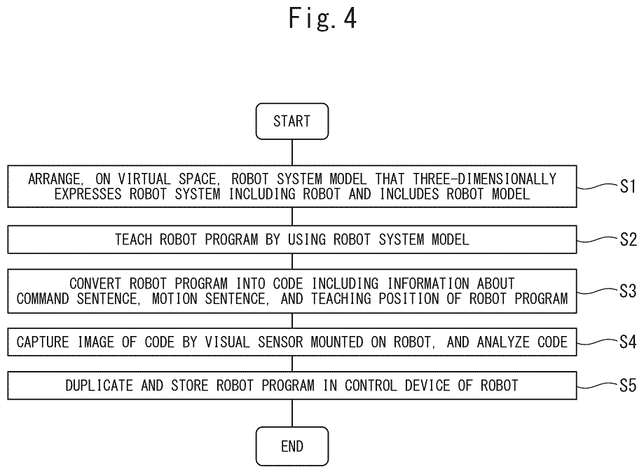

FIG. 4 is a flowchart illustrating a basic flow of a series of processing (hereinafter also described as robot program duplication processing), which is performed in the robot programming system 100, from creation of a robot program to duplication into the robot control device 50.

First, in the programming device 80, a robot system model that three-dimensionally expresses a robot system including a robot and includes a robot model is arranged on a virtual space (step S1). The processing in step S1 is performed by the virtual space creation unit 181 and the three-dimensional model arrangement unit 182.

Next, in step S2, an operator teaches motion to the robot system model (i.e., performs programming) under support by the robot program teaching unit 183.

Next, the programming device 80 (code conversion unit 185) converts the created robot program into a two-dimensional code including a command sentence, a motion sentence, and a teaching position described in the robot program (step S3). The two-dimensional code generated herein is displayed on the information medium 90 (for example, the tablet terminal 90A).

Next, in the robot system 110, the two-dimensional code displayed on the information medium 90 is captured by the visual sensor 21 mounted on the robot 10 under control by the code capturing unit 151, and is analyzed by the code analysis unit 152 (step S4). In this way, the command sentence, the motion sentence, and the teaching position of the robot program are restored.

Next, the robot control device 50 (the robot program duplication unit 153 and the robot program storage unit 154) duplicates and stores the restored robot program (step S5).

Hereinafter, a specific example of a series of operations from creation of a robot program using the programming device 80 to duplication and storage of the robot program into the robot control device 50 will be described.

### First Example

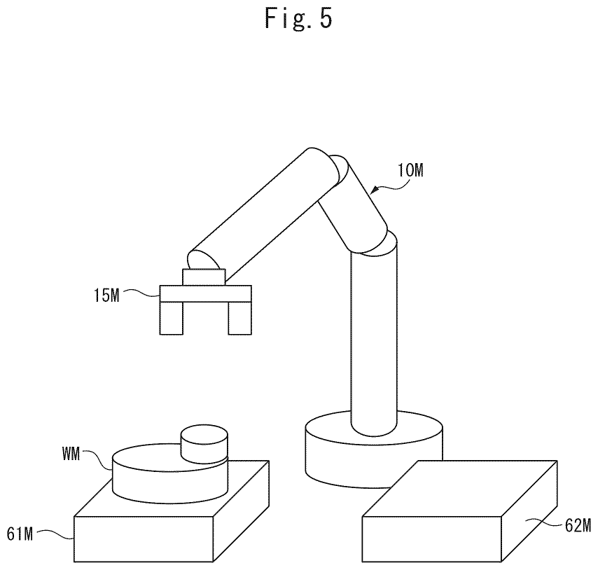

A first example will be described with reference to FIGS. 5 to 9. FIG. 5 illustrates a state where a robot model 10M, a workpiece model WM, and peripheral device models 61M and 62M are arranged in a virtual space created by the virtual space creation unit 181. The present example indicates an example in which a hand model 15M is attached as an end effector to an arm tip portion of the robot model 10M. The state where the models are arranged in the virtual space is displayed on the display screen of the programming device 80.

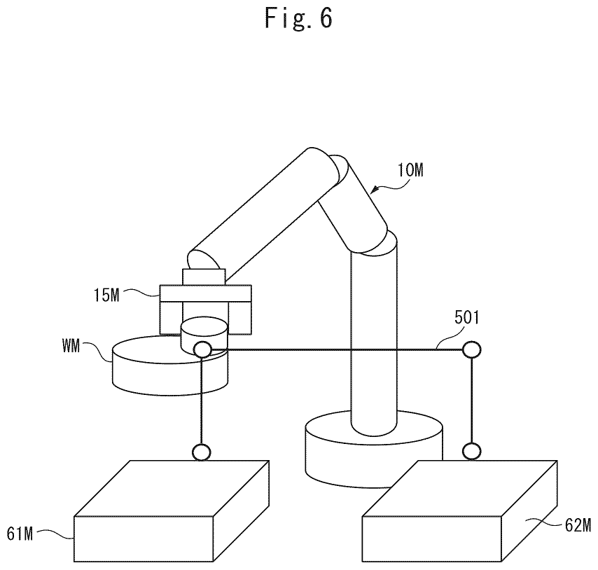

Next, an operator performs teaching of a robot program under support by the robot program teaching unit 183. Herein, an example in which the operator performs teaching of motion for picking-up a workpiece W placed on the peripheral device model 61M and arranging the workpiece W on the peripheral device model 62M will be described. As one example, as illustrated in FIG. 6, teaching is performed such that teaching points are adjusted one by one by a jog operation with respect to the robot model 10M on the virtual space. The operator designates a position at which the workpiece model WM is picked up and a position at which the workpiece model WM is arranged on the virtual space, and further designates a position of the workpiece model WM with respect to the hand model 15M when the workpiece model WM is held by the hand model 15M. A robot program 501 is automatically generated according to the teaching content designated in such a manner. FIG. 6 schematically illustrates a state where the robot program 501 is generated. The robot program 501 in this case includes information about motion commands and teaching points for positioning the hand model 15M at a picking-up position to hold the workpiece model WM, and moving the workpiece model WM to an arrangement position via a standby position and the like to arrange the workpiece model WM.

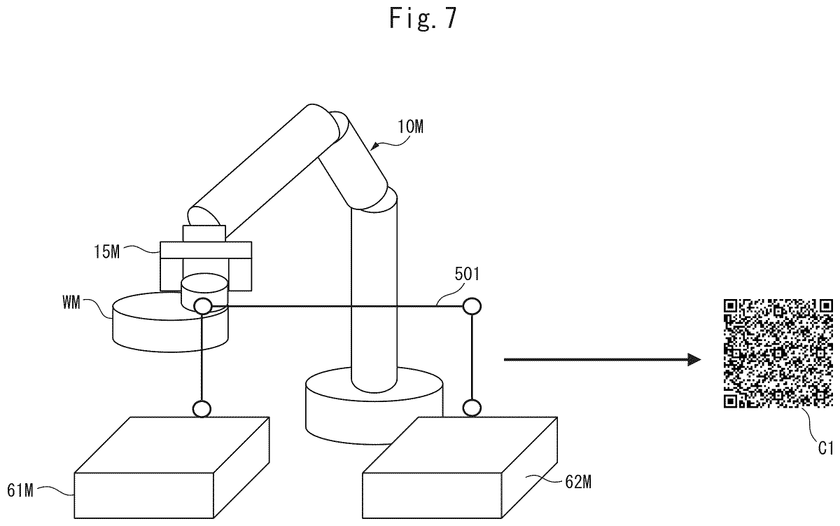

Next, the code conversion unit 185 converts the created robot program into a two-dimensional code. FIG. 7 schematically illustrates a state where the two-dimensional code C1 is generated by converting the robot program 501. The two-dimensional code C1 acquired herein is displayed on the information medium 90, and is positioned within an area which can be seen from the actual robot 10 (visual sensor 21).

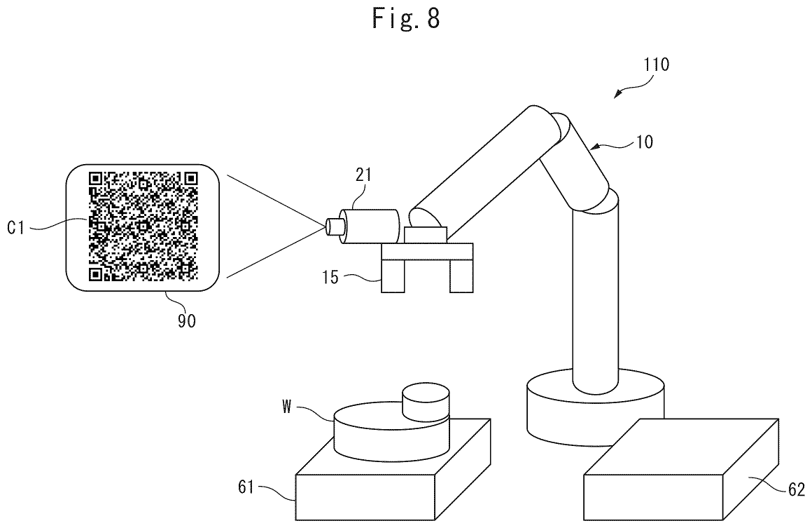

Next, as illustrated in FIG. 8, the two-dimensional code C1 displayed on the information medium 90 is captured by the visual sensor 21 mounted on the actual robot 10 and is read into the robot 10.

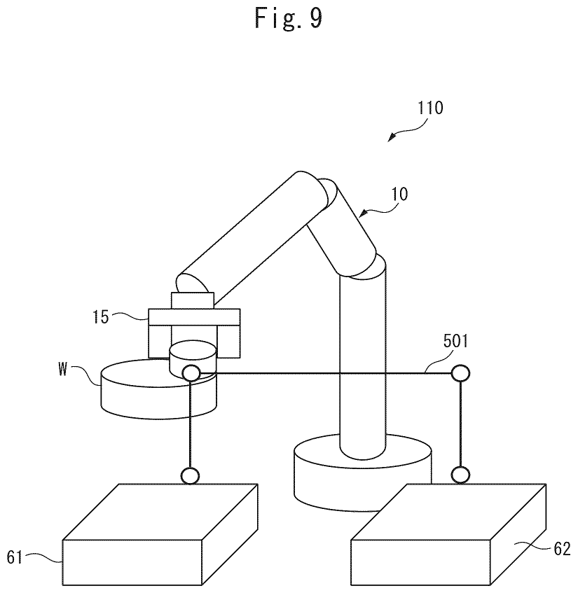

Next, the captured two-dimensional code is analyzed in the robot control device 50, and the robot program 501 is restored, and is duplicated and stored in the robot control device 50. FIG. 9 schematically illustrates a state where the robot program 501 is duplicated in the actual robot system 110.

In such a manner, according to the first example, a robot program created by the programming device 80 is represented as a two-dimensional code and read by the visual sensor 21 mounted on the robot 10, and thus the robot program can be duplicated and stored in the robot control device 50. In this way, time and effort required to apply the robot program created by the programming device 80 to the actual robot system 110 are reduced.

### Second Example

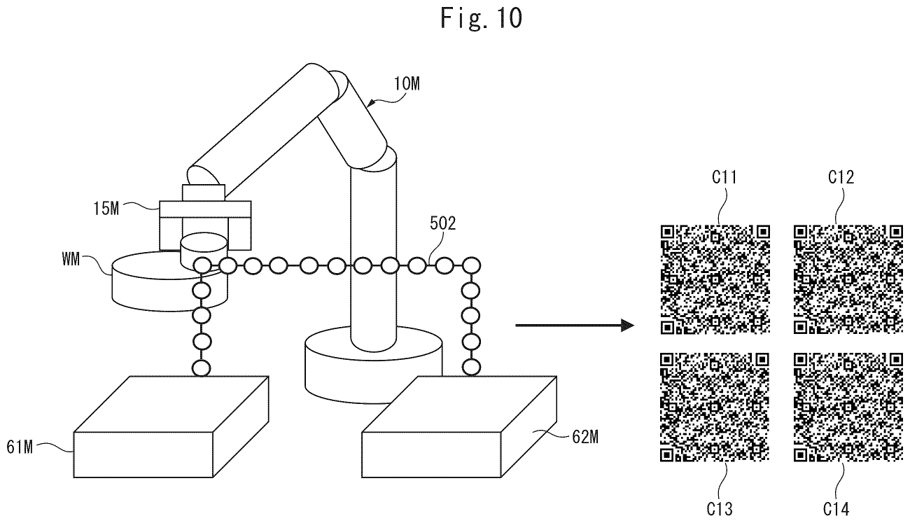

Hereinafter, a second example will be described with reference to FIGS. 10 to 12. The second example relates to the operation in which a robot program is divided into a plurality of portions and a two-dimensional code is generated for each divided portion, for example, when a data amount of the robot program is large.

As illustrated in FIG. 10, a robot program 502 is assumed to be created by the programming device 80. The robot program 502 has a great number of teaching points and a large amount of data. The robot program division unit 184 divides the robot program 502 by a predetermined rule. The predetermined rule is to, for example, (1) divide a robot program such that a data amount of each divided program falls within a capacity of one two-dimensional code, (2) divide a robot program for each group of contents in the robot program, and the like. In the present example, it is assumed that the robot program 502 is divided into four, and four two-dimensional codes C11, C12, C13, and C14 are generated. When a program is divided in such a manner, information indicating what number each divided program is may be included in each two-dimensional code.

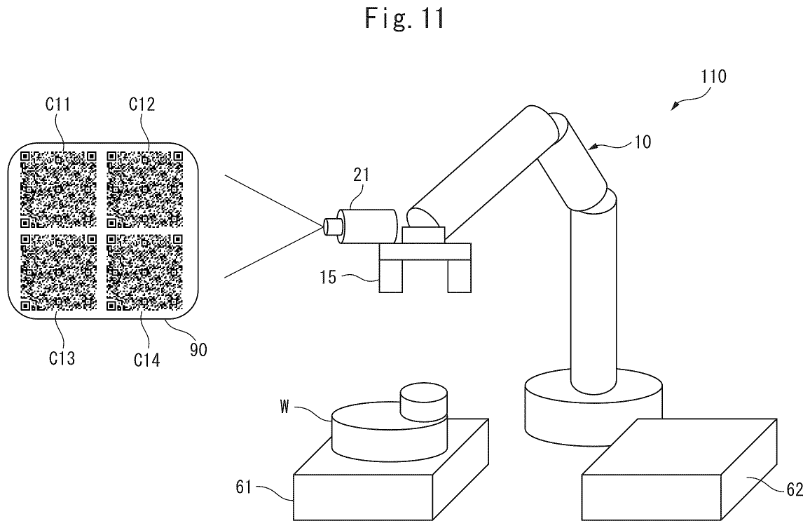

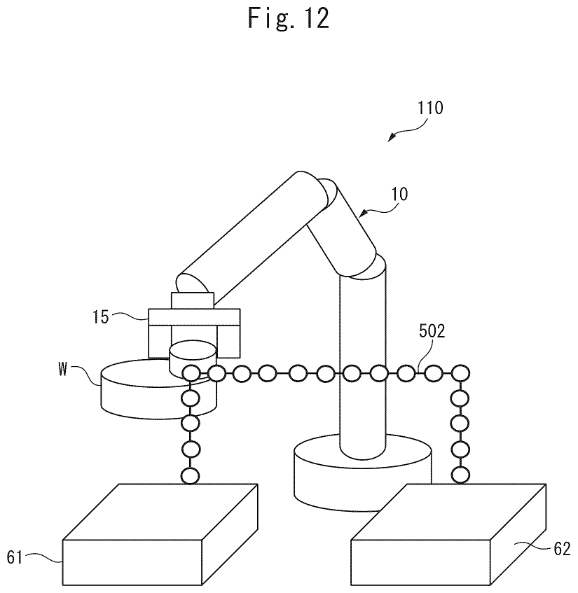

Next, as illustrated in FIG. 11, the two-dimensional codes C11 to C14 displayed on the information medium 90 are captured by the visual sensor 21 mounted on the actual robot 10. When the two-dimensional codes C11 to C14 are displayed on the display screen of the information processing device, the two-dimensional codes C11 to C14 may be simultaneously displayed on the display screen or may be displayed sequentially in chronological order. Each program encoded in each of the captured two-dimensional codes C11 to C14 is restored by the code analysis unit 152, and the entire robot program 502 is also restored by using information indicating the number of the program included in each of the two-dimensional codes. The robot program 502 restored in such a manner is duplicated and stored in the robot control device 50. FIG. 12 schematically illustrates a state where the robot program 502 is duplicated in the actual robot system 110.

In such a manner, according to the second example, even when the amount of a robot program is large, the robot program can be reliably applied to an actual robot while achieving the advantage of reducing the time and effort required to apply the robot program created by the programming device to the robot system as described above.

### Third Example

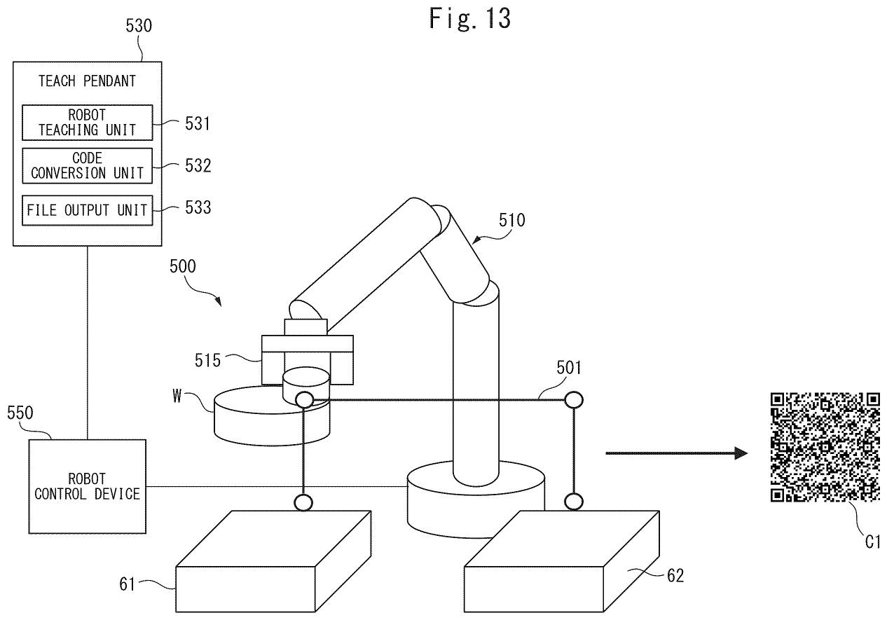

Hereinafter, a third example will be described with reference to FIG. 13. The third example relates to the operation in which a robot program created by using an actual robot system is applied to another robot system. The actual robot system being used for creating the robot program is assumed to be a robot system 500 illustrated in FIG. 13.

The robot system 500 includes a robot 510, a robot control device 550 that controls the robot 510, and a teach pendant (teaching device) 530 for teaching motion to the robot 510. In this configuration, the teach pendant 530 in the robot system 500 functions as a programming device for generating a robot program. FIG. 13 also illustrates a functional block diagram of the teach pendant 530.

As illustrated in FIG. 13, the teach pendant 530 includes a robot teaching unit 531, a code conversion unit 532, and a file output unit 533. The robot teaching unit 531 provides various functions for teaching (i.e., programming) such as a jog operation with respect to the robot 510 and setting of motion parameters. The code conversion unit 532 converts a robot program created under support by the robot teaching unit 531 into a two-dimensional code. The file output unit 533 provides a function of outputting the generated two-dimensional code as a file.

As illustrated in FIG. 13, the robot program 501 is assumed to be created by using the teach pendant 530 in the robot system 500. The teach pendant 530 converts the robot program 501 into the two-dimensional code C1.

The generated two-dimensional code C1 is displayed on the information medium 90 (for example, a display screen of a tablet terminal), and is duplicated, in the manner described with reference to FIG. 8, to the robot system 110 serving as another robot system.

It should be noted that the teach pendant 530 may further include the function as the code display unit 186 in order for the teach pendant 530 itself to also function as a device for displaying a two-dimensional code. In this case, the two-dimensional code C1 displayed on a display screen of the teach pendant 530 can be read into the visual sensor 21 of the robot system 110 serving as another robot system. In this case, the teach pendant 530 may be formed of a tablet terminal.

Alternatively, a two-dimensional code representing a robot program created in the robot system 500 may be transferred to a tablet terminal and the like via a PC by an e-mail function and the like so that the two-dimensional code can be displayed on the tablet terminal and the like, and read by a visual sensor of another robot system.

As described above, also in the situation where a robot program created in an actual robot system is applied to another robot system, it is possible to attain the advantage of greatly reducing the time and effort required to apply the robot program to the robot system.

Hereinafter, a specific example of what kind of a device constitutes the programming device 80 and what kind of a device or a medium is used as the information medium 90 that displays a two-dimensional code will be described.

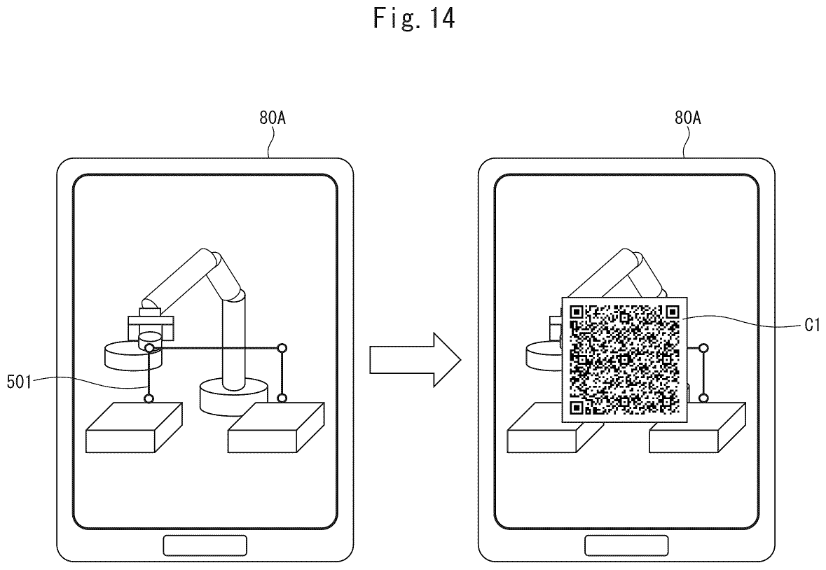

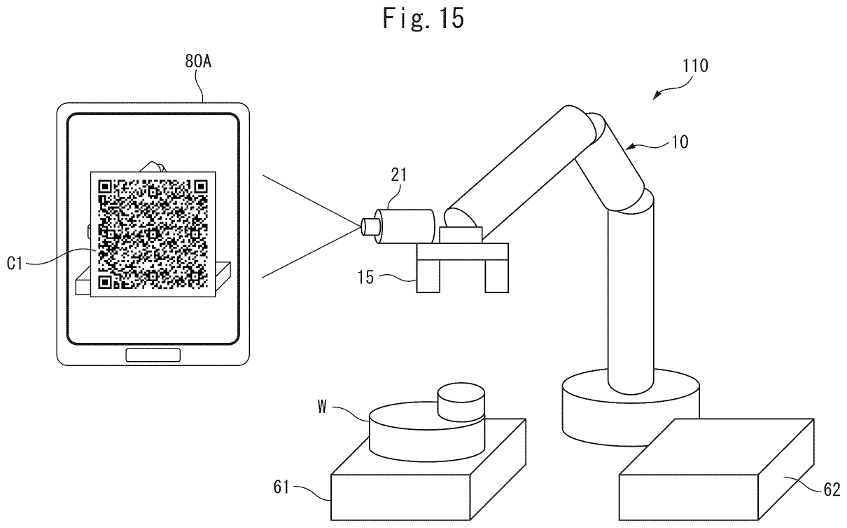

With reference to FIGS. 14 and 15, a case where a tablet terminal 80A is used as the programming device 80, and the tablet terminal 80A is also used as a display device for displaying a two-dimensional code will be described.

As illustrated in FIG. 14, in the present example, the robot program 501 is created by using the tablet terminal 80A. The robot program 501 is converted into the two-dimensional code C1 by the code conversion unit 185 of the tablet terminal 80A, and is displayed on a display screen of the tablet terminal 80A.

As illustrated in FIG. 15, a worker causes the two-dimensional code C1 to be read into the visual sensor 21 by arranging, at a predetermined position within an image capturing area of the visual sensor 21, the tablet terminal 80A on which the two-dimensional code C1 is displayed, or holding, by his/her hands, the tablet terminal 80A on which the two-dimensional code C1 is displayed, at the predetermined position. In this way, the robot program 501 is duplicated and stored in the robot system 110.

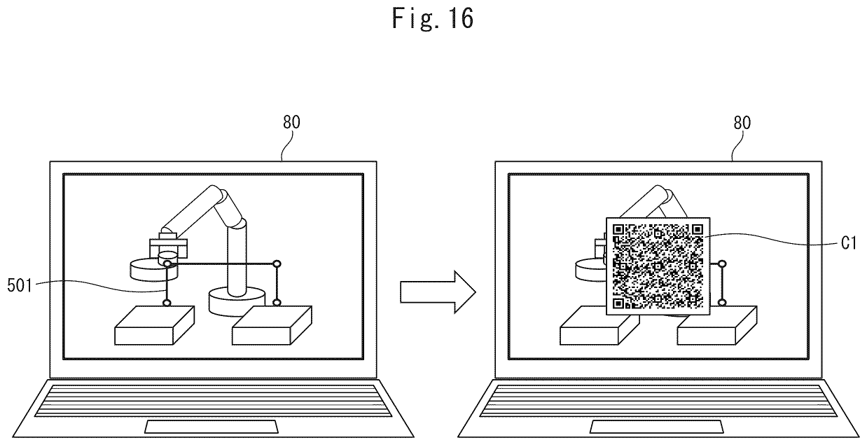

Hereinafter, a specific configuration example of presenting the two-dimensional code C1 to the robot system will be described with reference to FIGS. 16 to 18.

As illustrated in FIG. 16, in the present example, a personal computer (PC) is used as the programming device 80. The programming device 80 may be arranged at a place remote from a place where the robot system 110 is installed. The robot program 501 is assumed to be created by using the programming device 80. The robot program 501 is converted into the two-dimensional code C1 by the code conversion unit 185 of the programming device 80 and is output as a file by the file output unit 187.

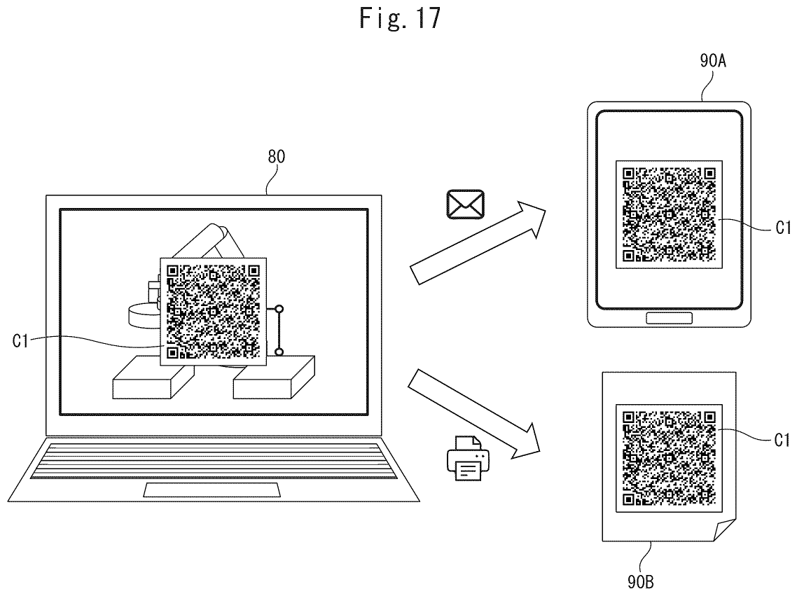

As illustrated in FIG. 17, the two-dimensional code C1 created by using the programming device 80 may be transferred to the tablet terminal 90A of a worker from the programming device 80 by an e-mail function, or may be printed out from a printer connected to the programming device 80. When the two-dimensional code C1 is printed, a printed paper medium 90B functions as the information medium 90.

When the two-dimensional code C1 is transferred to the tablet terminal 90A and displayed, the two-dimensional code displayed on the tablet terminal 90A can be read into the visual sensor 21 of the robot system 110 in the manner as described above with reference to FIG. 15.

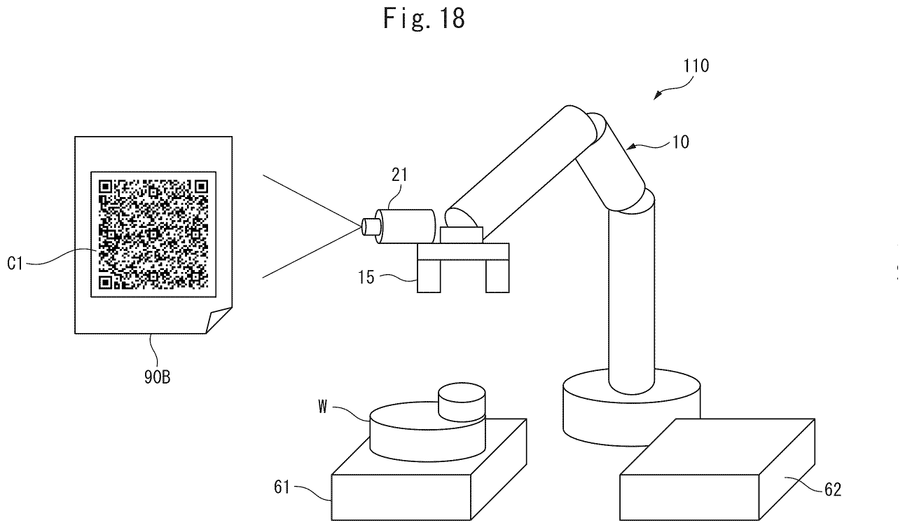

When the two-dimensional code is printed out, the paper medium 90B on which the two-dimensional code C1 is printed as illustrated in FIG. 18 is read into the visual sensor 21 by arranging the paper medium 90B at a predetermined position within an image capturing area of the visual sensor 21 or holding the paper medium 90B by the worker. In this way, the robot program 501 is duplicated and stored in the robot system 110.

As described above, according to the present embodiment, the time and effort required to apply a robot program created by the programming device to the robot system can be greatly reduced as compared to the case where a robot program is applied to a robot system by using a USB memory, and the like.

It should be noted that, in the configuration illustrated in FIG. 1, a data file of the two-dimensional code C1 generated by the programming device 80 may be transferred to the teach pendant 30 of the robot system 110 by an e-mail function, and the two-dimensional code C1 may be displayed on the display screen of the teach pendant 30 and read into the visual sensor 21. In this case, the teach pendant 30 may be formed of a tablet terminal.

### Second Embodiment

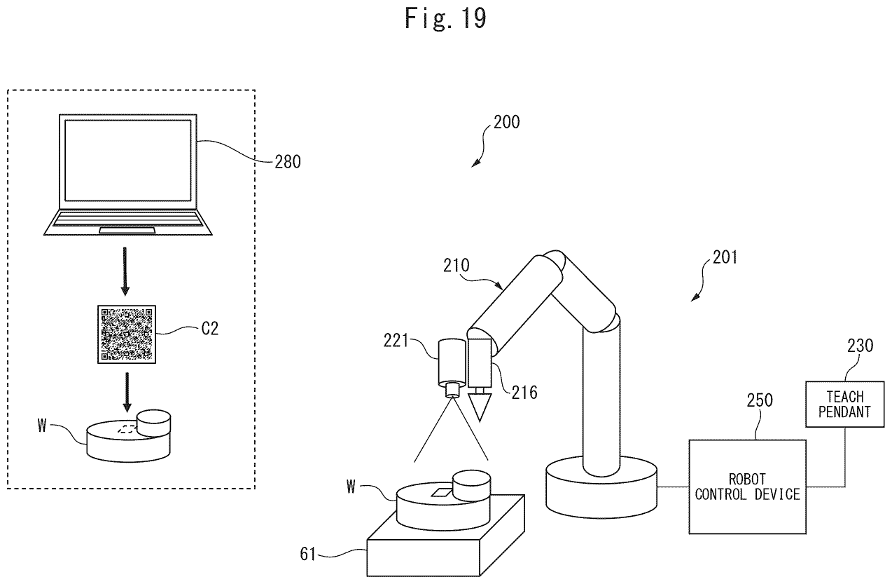

FIG. 19 is a diagram illustrating an apparatus configuration of a robot programming system 200 according to the second embodiment. As illustrated in FIG. 19, the robot programming system 200 includes a programming device 280 having functions of creating a robot program and converting the robot program into a two-dimensional code, and a robot system 201 having functions of capturing an image of the two-dimensional code by a visual sensor 221, and restoring and duplicating the robot program. In the present embodiment, a two-dimensional code of a robot program in a state of being attached to a workpiece W being a work target is carried into the robot system 201.

As illustrated in FIG. 19, the robot system 201 includes a robot 210, a robot control device 250 that controls the robot 210, and a teach pendant (teaching device) 230 connected to the robot control device 250. The visual sensor 221 is mounted on an arm tip of the robot 210. The workpiece W being a work target is placed on a peripheral device 61. The visual sensor 221 is connected to the robot control device 250, and operates under the control of the robot control device 250.

The robot 210 can perform desired work by using an end effector attached to a wrist portion of the arm tip. FIG. 19 illustrates an example in which a grinding tool 216 is used as the end effector.

In the robot programming system 200, a robot program which is created by the programming device 280 and of which the instructions depend on a workpiece being a work target is converted into a two-dimensional code C2, printed onto a medium, and attached to a predetermined position of the workpiece. For example, when the workpiece W is carried into a workspace of the robot system 201 by a carrying device, an image of the two-dimensional code C2 on the workpiece W is captured by the visual sensor 221 in the robot system 201, and the robot program is restored and duplicated in the robot system 201. Accordingly, the robot system 201 can execute the robot program applied to the workpiece W. The robot system 201 can duplicate the robot program applied to the workpiece W by reading the two-dimensional code attached to the workpiece W, and therefore there is no need to store the robot program for the workpiece W in advance in the robot system 201 (robot control device 250).

The programming device 280 can create a robot program by arranging a robot system model including a robot model and a workpiece model on a virtual space and teaching the motion to the robot model on the virtual space. As the programming device 280, a PC, a tablet terminal, and other various information processing devices may be used.

Hardware configuration examples of the programming device 280, the robot control device 250, and the teach pendant 230 are similar to the hardware configuration examples of the programming device 80, the robot control device 50, and the teach pendant 30 illustrated in FIG. 2, respectively.

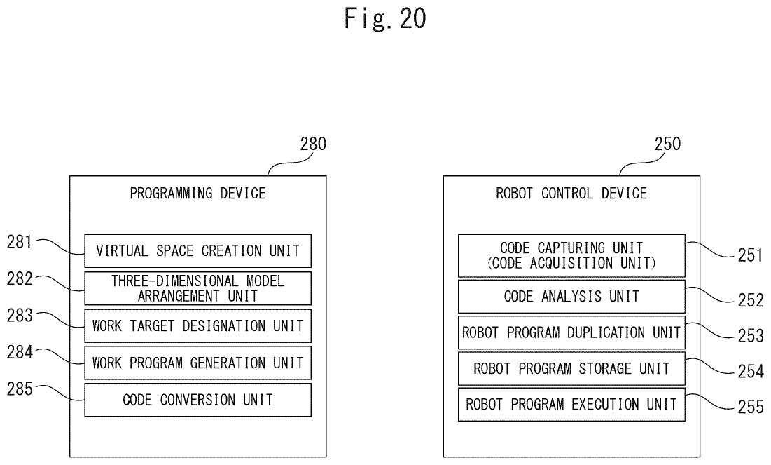

FIG. 20 is a functional block diagram of the programming device 280 and the robot control device 250. As illustrated in FIG. 20, the programming device 280 includes a virtual space creation unit 281, a three-dimensional model arrangement unit 282, a work target designation unit 283, a work program generation unit 284, and a code conversion unit 285. The robot control device 250 includes a code capturing unit 251, a code analysis unit 252, a robot program duplication unit 253, a robot program storage unit 254, and a robot program execution unit 255.

In the programming device 280, the virtual space creation unit 281 creates a virtual space for arranging various models constituting a robot system. The three-dimensional model arrangement unit 282 arranges, in the virtual space, three-dimensional models, such as a robot model and a workpiece model, of objects constituting the robot system, based on arrangement information about the actual robot system. The robot system model arranged in the virtual space is displayed on a display screen of the programming device 280.

The work target designation unit 283 has the functions of supporting an operation by an operator of designating a work target part of the workpiece model displayed on the virtual space (display screen), based on a shape feature (such as a contour line and a surface) of the workpiece W that can be extracted from a three-dimensional model of the workpiece W, and identifying the designated work target part.

The work program generation unit 284 automatically generates a robot program for performing predetermined work using a work tool with respect to the work target part identified by the work target designation unit 283.

The code conversion unit 285 converts the created robot program into a two-dimensional code.

The code capturing unit 251 of the robot control device 250 captures, by the visual sensor 221, an image of the two-dimensional code attached to the workpiece W carried into the workspace. It should be noted that the code capturing unit 251 can also be expressed as a code acquisition unit that acquires information about an image in which a code attached to the workpiece W is captured by the visual sensor 221.

The robot control device 250 may have, as an internal function, a function as a visual sensor control device that controls the visual sensor 221. Alternatively, the visual sensor control device that controls the visual sensor 221 may be provided, to the robot system 201, separately from the robot control device 250. In the latter case, the robot control device 250 controls the visual sensor 221 via the visual sensor control device, and acquires an image captured by the visual sensor 221 via the visual sensor control device.

The code analysis unit 252 analyzes the captured image of the two-dimensional code so as to restore the robot program.

The robot program duplication unit 253 duplicates the restored robot program, and stores the duplicated robot program in the robot program storage unit 254. The robot program execution unit 255 has a function of executing the duplicated robot program.

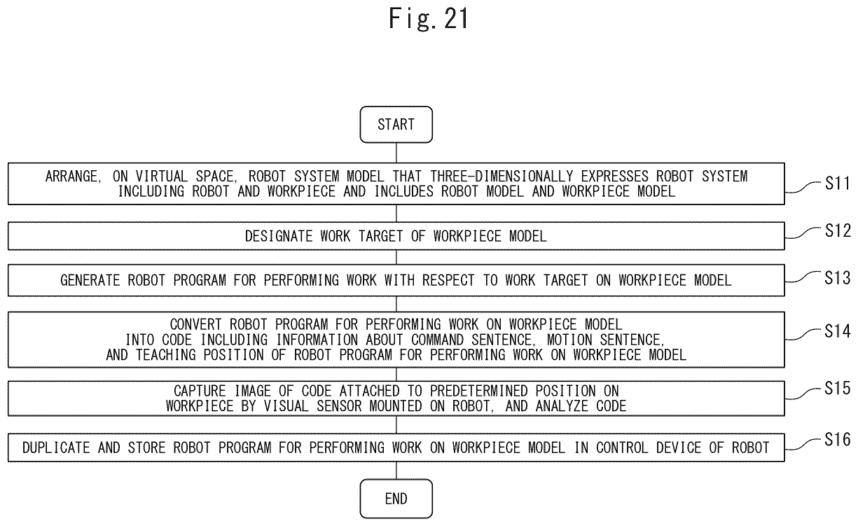

FIG. 21 is a flowchart illustrating a basic flow of a series of processing (also described as robot program duplication processing), which is performed in the robot programming system 200, from creation of a robot program to duplication into the robot control device 250.

First, in the programming device 280, a robot system model that three-dimensionally expresses a robot system including a robot and a workpiece and includes a robot model and a workpiece model is arranged on a virtual space (step S11). The processing in step S11 is performed by the virtual space creation unit 281 and the three-dimensional model arrangement unit 282.

Next, designation of a work target of the workpiece model is performed by an operator under support by the work target designation unit 283 (step S12).

Next, the work program generation unit 284 executes automatic generation of a robot program for performing work with respect to the designated work target on the workpiece model (step S13).

Next, the code conversion unit 285 converts the robot program for performing work on the workpiece model into a two-dimensional code including information about a command sentence, a motion sentence, and a teaching position described in the robot program for performing work on the workpiece model (step S14). As an exemplification, the two-dimensional code is printed on a medium, and is attached to a predetermined position of the workpiece which can be seen from the visual sensor 221 in a posture of the robot 210 as illustrated in FIG. 19, for example.

Next, the robot control device 250 (the code capturing unit 251 and the code analysis unit 252) operates to capture an image of the two-dimensional code attached to the predetermined position on the workpiece W by using the visual sensor 221 mounted on the robot 210, and analyze the two-dimensional code by using the captured image (step S15). In this way, the command sentence, the motion sentence, and the teaching position of the robot program are restored.

Next, the robot control device 250 (the robot program duplication unit 253 and the robot program storage unit 254) duplicates and stores the robot program for performing work on the workpiece W (step S16).

Hereinafter, a specific motion example of the robot programming system 200 will be described.

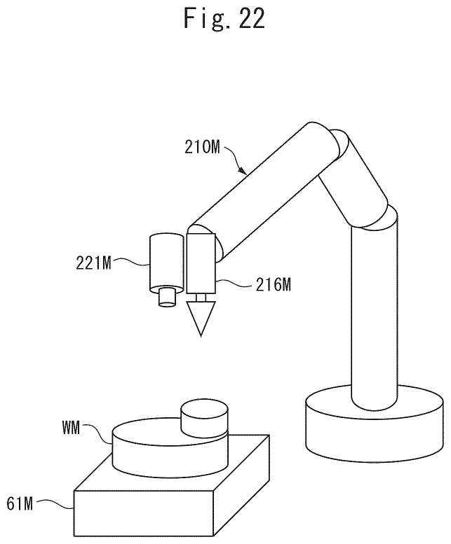

FIGS. 22 to 24 are diagrams illustrating a first creation example of a robot program having the instructions depending on a workpiece. FIG. 22 illustrates a state where a robot model 210M, a workpiece model WM, and a peripheral device model 61M are arranged in a virtual space (display screen) by the programming device 280. A visual sensor model 221M and a grinding tool model 216M as a work tool are attached to an arm tip portion of the robot model 210M.

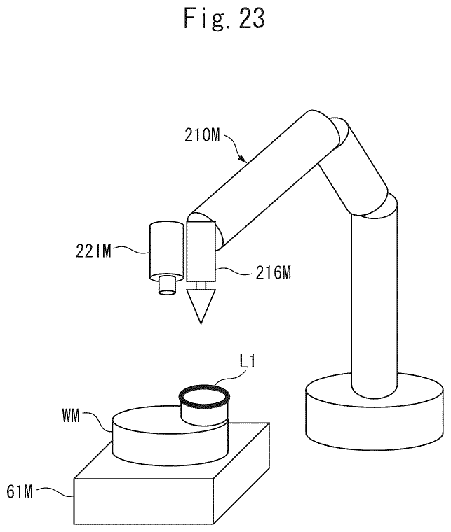

FIG. 23 illustrates a state where an operator designates an edge line L1 of an upper cylindrical portion of the workpiece model WM under support by the work target designation unit 283.

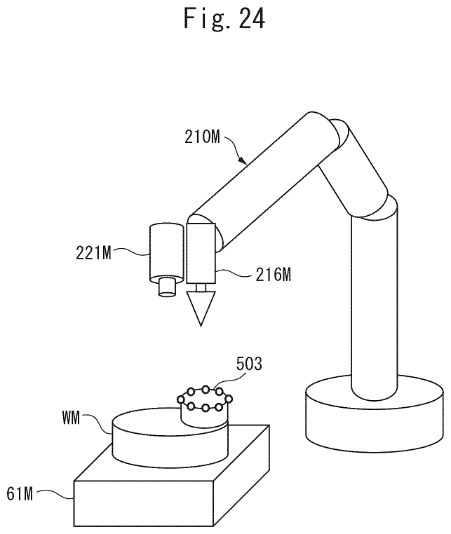

Next, as illustrated in FIG. 24, the work program generation unit 284 automatically generates a robot program 503 for performing grinding work by moving the grinding tool model 216M along the designated edge line L1. The robot program 503 in this case includes information about a plurality of teaching points along the edge line Ll and a motion command for moving the grinding tool model 216M along the edge line L1 via the teaching points.

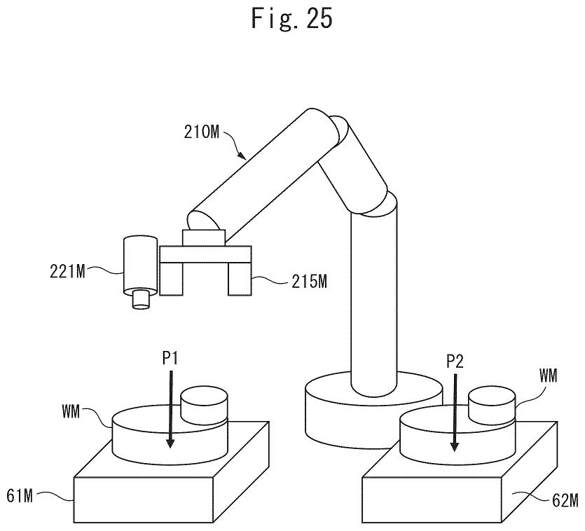

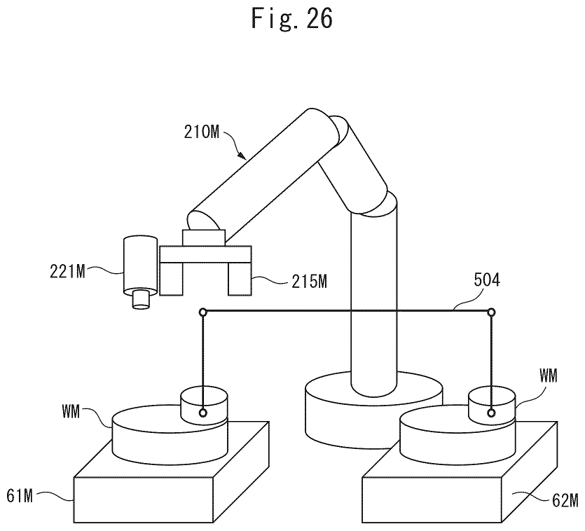

FIGS. 25 and 26 are diagrams illustrating a second creation example of a robot program having the instructions depending on a workpiece. FIG. 25 illustrates a state where the robot model 210M, the workpiece model WM, the peripheral device model 61M, and a peripheral device model 62M are arranged in a virtual space (display screen). As illustrated in FIG. 25, in the present example, the visual sensor model 221M and a hand model 215M as a work tool are attached to an arm tip portion of the robot model 210M.

In the present example, an operator designates, as a work target, a picking-up position P1 and an arrangement position P2 of the workpiece WM on the virtual space (display screen) under support by the work target designation unit 283.

Subsequently, as illustrated in FIG. 26, the work program generation unit 284 automatically generates a robot program 504 for picking up the workpiece model WM from the picking-up position P1 by using the hand model 215M and arranging the workpiece model WM at the arrangement position P2. The robot program 504 includes information about motion commands and teaching points for positioning the hand model 215M at the picking-up position P1 to hold the workpiece model WM, and arranging the workpiece model WM by moving the workpiece model WM to the arrangement position P2 via a way point.

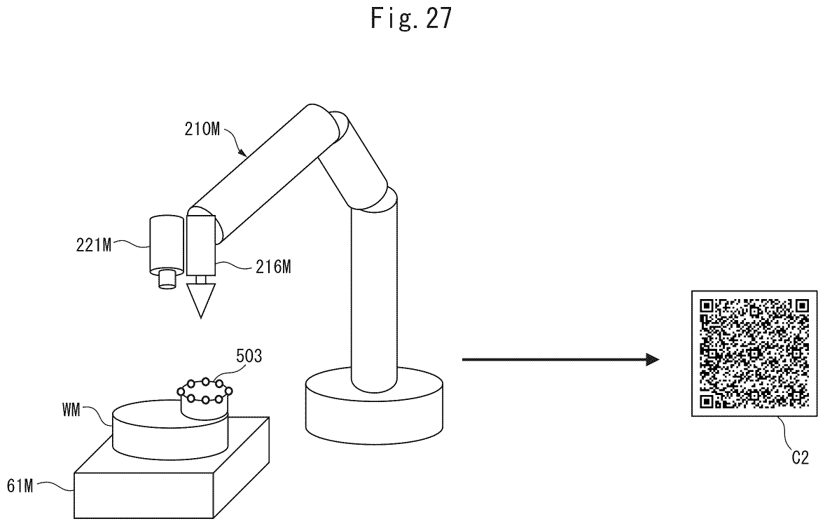

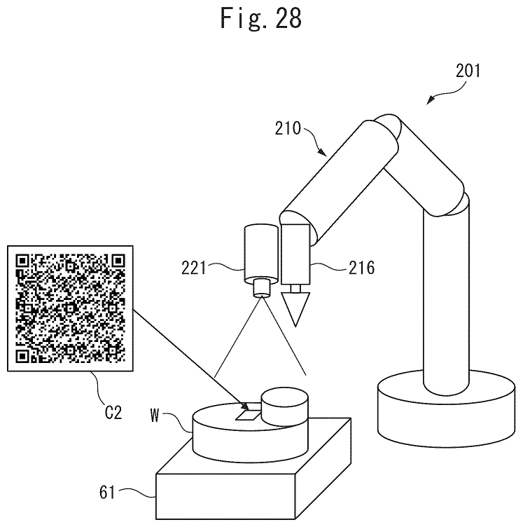

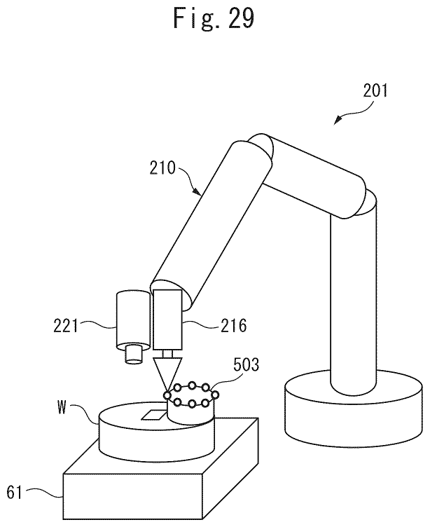

As schematically illustrated in FIG. 27, the code conversion unit 285 of the programming device 280 converts the robot program 503 generated as described above into the two-dimensional code C2. The two-dimensional code C2 is printed on a predetermined medium by a printing device (not illustrated) and attached to a predetermined position of the workpiece W before work. As illustrated in FIG. 28, when the workpiece W is carried into a workspace, the robot 210 (robot control device 250) captures, by using the visual sensor 221, an image of the two-dimensional code C2 attached to the predetermined position of the workpiece W. The two-dimensional code is analyzed by the robot control device 250 (code analysis unit 252), and the robot program 503 is restored, and is duplicated and stored in the robot control device 250. In this way, as illustrated in FIG. 29, the actual robot 210 can execute the robot program 503 with respect to the workpiece W.

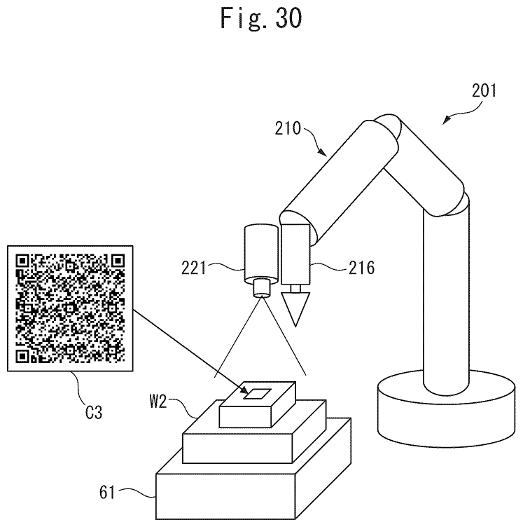

After work on the workpiece W is completed, it is assumed that a different workpiece W2 is carried into the workspace as illustrated in FIG. 30. Also in this case, the robot 210 (robot control device 250) reads a two-dimensional code C3 attached to the workpiece W2 by the visual sensor 221, and can thus duplicate and store a robot program for the workpiece W2 being encoded as the two-dimensional code C3.

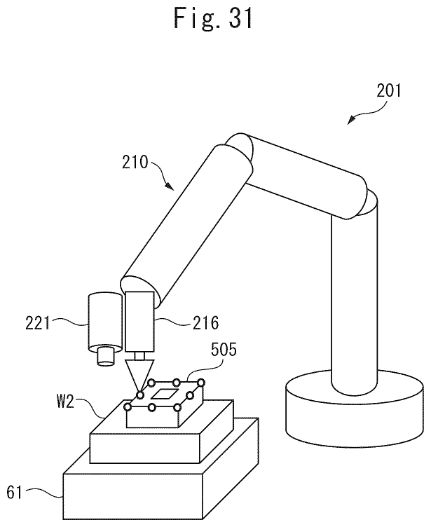

Accordingly, as illustrated in FIG. 31, the actual robot 210 can execute a robot program 505 corresponding to the two-dimensional code C3 with respect to the workpiece W2.

As described above, according to the present embodiment, the time and effort required to apply a motion program created by the programming device to the robot system can be greatly reduced as compared to the case where a robot program is applied to a robot system by using a USB memory and the like.

Furthermore, according to the present embodiment, a two-dimensional code encoding a robot program of which the instructions depend on a workpiece is attached to the workpiece carried into a workspace, and thus the robot system does not need to store a robot program for processing the workpiece. Further, after a program for a workpiece carried into the workspace is finished, the robot control device can read a two-dimensional code representing a next program attached to a workpiece to be processed next. Therefore, the robot control device 250 (robot program execution unit 255) can delete the program of the workpiece for which the work is finished.

Accordingly, it is possible to prevent the storage area in the robot control device 250 from being excessively consumed by the programs. It should be noted that, in particular, when a wide variety of workpieces are handled in the robot system, it is possible to prevent the storage area in the robot control device 250 from being excessively consumed by the programs.

It should be noted that, in a situation where the work is repeatedly performed for the same workpieces, information about how many workpieces are continuously carried into the workspace (information about the number of workpieces) may be included in a two-dimensional code. When the information about the number of workpieces is included in the two-dimensional code attached to the workpiece carried into the workspace, the robot control device 250 holds a robot program and repeatedly executes the robot program for the designated number of workpieces. Then, when the work is finished for the designated number of workpieces, the robot control device 250 deletes the robot program. It should be noted that, in this case, the two-dimensional code may be attached to only a first workpiece of the plurality of workpieces being continuously carried into the workspace.

Regarding the second embodiment in which a two-dimensional code is attached to a workpiece, modifications described below are also possible. For example, a configuration example of displaying a two-dimensional code on a display device such as a tablet terminal is possible. In this case, the display device is arranged at a predetermined position in a workspace, and a two-dimensional code of a robot program for a workpiece is displayed on the display device at a timing when the workpiece is carried into the workspace. Furthermore, when a sensor (such as a camera) arranged on an upstream side on a conveying path of the workpiece detects that the workpiece is carried into the workspace, the display device is notified of the fact that the workpiece is being carried into the workspace. Two-dimensional codes of a plurality of kinds of robot programs have been transferred from the programming device to the display device and stored in the display device. Further, the notification from the sensor additionally includes information indicating the kind of a workpiece carried into the workspace. When the display device receives the notification, the display device identifies a two-dimensional code of a robot program for processing a workpiece corresponding to the notification, and displays the two-dimensional code.

As described above, according to each of the present embodiments, the time and effort required to apply a motion program created by the programming device to the robot system can be greatly reduced as compared to the case where the robot program is applied to the robot system by using a USB memory and the like.

The present invention has been described above by using the typical embodiments, but it will be understood by those of ordinary skill in the art that changes, other various changes, omission, and addition may be made in each of the embodiments described above without departing from the scope of the present invention.

In the embodiments described above, the configuration example in which the visual sensor for capturing an image of a two-dimensional code is mounted on the robot is described, but a configuration example in which the visual sensor is installed at a fixed position in a workspace is also possible. In this case, an information medium (for example, a tablet terminal) that displays the two-dimensional code is positioned at a predetermined position within an image capturing area of the visual sensor, and the two-dimensional code is read by the visual sensor.

The functional blocks of the programming device, the robot control device, and the device for displaying a two-dimensional code described with reference to FIGS. 3 and 20 may be achieved by executing various types of software stored in a storage device by the processor of the devices, or may be achieved by a configuration in which hardware such as an application specific integrated circuit (ASIC) is a main body.

The program for executing various pieces of processing such as the robot program duplication processing in the embodiments described above can be recorded in various computer-readable recording media (for example, a ROM, an EEPROM, a semiconductor memory such as a flash memory, a magnetic recording medium, and an optical disk such as a CD-ROM and a DVD-ROM).

### REFERENCE SIGNS LIST

10 Robot
10M Robot model
15 Hand
15M Hand model
21 Visual sensor
30 Teach pendant
31 Processor
32 Memory
33 Display unit
34 Operation unit
35 Input/output interface
50 Robot control device
51 Processor
52 Memory
53 Input/output interface
54 Operation unit
61, 62 Peripheral device
61M, 62M Peripheral device model
80 Programming device
81 Processor
82 Memory
83 Display unit
84 Operation unit
85 Storage device
86 Input/output interface
90 Information medium
90A Tablet terminal
100 Robot programming system
110 Robot system
151 Code capturing unit
152 Code analysis unit
153 Robot program duplication unit
154 Robot program storage unit
181 Virtual space creation unit
182 Three-dimensional model arrangement unit
183 Robot program teaching unit
184 Robot program division unit
185 Code conversion unit
186 Code display unit
187 File output unit
191 Code display unit
200 Robot programming system
201 Robot system
210 Robot
210M Robot model
215M Hand model
216 Grinding tool
216M Grinding tool model
221 Visual sensor
221M Visual sensor model
230 Teach pendant
250 Robot control device
251 Code capturing unit
252 Code analysis unit
253 Robot program duplication unit
254 Robot program storage unit
255 Robot program execution unit
281 Virtual space creation unit
282 Three-dimensional model arrangement unit
283 Work target designation unit
284 Work program generation unit
285 Code conversion unit
W Workpiece
WM Workpiece model

1. A robot programming system comprising:
a first information processing device including a code conversion unit configured to convert a robot program into a code;
a visual sensor configured to capture an image of the code displayed on an information medium; and
a robot control device configured to control a robot,
the robot control device comprising:
a code analysis unit configured to analyze a captured image of the code so as to restore the robot program; and
a robot program duplication unit configured to duplicate the restored robot program and store the duplicated robot program in a storage unit.

2. The robot programming system according to claim 1, wherein
the first information processing device is a programming device including:
a model arrangement unit configured to arrange, on a virtual space, a robot system model that three-dimensionally expresses a robot system including the robot and includes a robot model;
a robot program teaching unit configured to perform teaching with respect to the robot system model according to a user input; and
the code conversion unit configured to convert the robot program created by the teaching into a code including information about a command sentence, a motion sentence, and a teaching position of the robot program.

3. The robot programming system according to claim 1, wherein the first information processing device is a teaching device configured to teach motion to an actual robot and generate the robot program.

4. The robot programming system according to claim 1, wherein the information medium on which the code is displayed is a display screen of a second information processing device.

5. The robot programming system according to claim 4, wherein the first information processing device transfers the code to the second information processing device by an e-mail function.

6. The robot programming system according to claim 1, wherein the information medium on which the code is displayed is a display screen of the first information processing device.

7. The robot programming system according to claim 1, wherein the information medium on which the code is displayed is a paper medium.

8. The robot programming system according to claim 1, wherein
the first information processing device further includes a robot program division unit configured to divide the robot program into a plurality of robot programs,
the code conversion unit generates a plurality of codes respectively corresponding to the plurality of divided robot programs,
the visual sensor captures an image of the plurality of codes, and
the code analysis unit restores the entire robot program from the captured image of the plurality of codes.

9. The robot programming system according to claim 1, wherein
the first information processing device is a programming device including:
a model arrangement unit configured to arrange, on a virtual space, a robot system model that three-dimensionally expresses a robot system including the robot and a workpiece and includes a robot model and a workpiece model;
a work target designation unit configured to designate a work target of the workpiece model;
a work program generation unit configured to generate a robot program for performing work with respect to the designated work target; and
the code conversion unit configured to convert the generated robot program into a code including information about a command sentence, a motion sentence, and a teaching position of the robot program.

10. The robot programming system according to claim 9, wherein the information medium on which the code is displayed is a medium on which the code is printed and is attached to a predetermined position on the workpiece.

11. The robot programming system according to claim 9, wherein
the robot control device further includes a program execution unit configured to execute the duplicated robot program, and
the program execution unit deletes the duplicated robot program stored in the storage unit after execution of the duplicated robot program with respect to the workpiece is finished.

12. The robot programming system according to claim 9, wherein
the robot control device further includes a program execution unit configured to execute the duplicated robot program,
the code includes information about a number of workpieces for which the robot program needs to be executed, and
the program execution unit deletes the robot program stored in the storage unit after the program execution unit repeatedly executes the robot program by the number of workpieces.

13. A robot control device configured to control a robot, the robot control device comprising:
a code acquisition unit configured to acquire information about an image of a code encoding a robot program, the image being captured by a visual sensor;
a code analysis unit configured to analyze the information about the image of the code so as to restore the robot program; and
a robot program duplication unit configured to duplicate the restored robot program and store the duplicated robot program in a storage unit.

14. A robot control device configured to control a robot, the robot control device comprising:
a code acquisition unit configured to acquire information about an image of a code encoding a robot program for performing work depending on a workpiece, wherein the code is attached to the workpiece and the image is captured by a visual sensor;
a code analysis unit configured to analyze the information about the image of the code so as to restore the robot program;
a robot program duplication unit configured to duplicate the restored robot program and store the duplicated robot program in a storage unit; and
a program execution unit configured to execute the duplicated robot program.

15. The robot control device according to claim 14, wherein the program execution unit deletes the duplicated robot program stored in the storage unit after execution of the duplicated robot program with respect to the workpiece is finished.
